(19) United States
(12) Patent Application Publication
(10) Pub. No.: US 2026/0286648 A1
(43) Pub. Date: Sep. 24, 2026

(54) WORKING VEHICLE AND METHOD FOR MANUFACTURING WORKING VEHICLE

(71) Applicant: TAKEUCHI MFG. CO., LTD., Hanishina-gun (JP)

(72) Inventors: Hidaka Oyama, Hanishina-gun (JP); Keigo Kita, Hanishina-gun (JP)

(73) Assignee: TAKEUCHI MFG. CO., LTD., Hanishina-gun (JP)

(21) Appl. No.: 19/283,427

(22) Filed: Jul. 29, 2025

(30) Foreign Application Priority Data
Mar. 21, 2025 (JP) 2025-046390

(51) Int. Cl. E02F 9/08; B60L 15/00; B62D 65/02; E02F 3/32; E02F 3/42; E02F 9/22

(52) U.S. Cl. CPC E02F 9/0866; B60L 15/007; B62D 65/02; E02F 3/325; E02F 3/425; B60L 2200/40; E02F 9/2203; E02F 9/2292

(57) ABSTRACT

A working vehicle according to the present invention is a working vehicle including an upper body having a device compartment, and a hydraulically operating working device. The device compartment is provided with an electric motor serving as a drive source of the working device, and an inverter supplying electricity to the electric motor. The device compartment includes a partition member separating an internal space into a first space where the electric motor is arranged and a second space on a side opposite thereto. The inverter is attached to the partition member and has a heat dissipator arranged in the first space and a terminal connection part arranged in the second space.

### CROSS-REFERENCE TO RELATED APPLICATION

This application is based upon and claims the benefit of priority of the prior Japanese Patent Application No. P2025-046390, filed on March 21, 2025, and the entire contents of which are incorporated herein by reference.

### Technical Field

The present invention relates to a working vehicle and a method for manufacturing the working vehicle.

### Background Art

As an example of a working vehicle, a hydraulic excavator, a track loader or the like having a lower body with a traveling crawler or tire installed thereon, an upper body arranged above the lower body, and a working device installed at the lower body or the upper body and operating hydraulically (that is, with hydraulic oil having a predetermined pressure) is known according to the related art.

Recently, a working vehicle having an electric motor instead of a traditional engine as a drive source of a working device has been developed (refer to JP-A-2007-325431).

### SUMMARY OF INVENTION

### Technical Problem

In the electric working vehicle exemplified in JP-A-2007-325431 or the like, since an electric motor as a drive source and an inverter that supplies electricity to the electric motor generate heat at the time of operation, it is common to employ a configuration in which an opening is provided in a cover and in which a blower fan is driven and a cooling air is taken in from the opening and applied to the electric motor and the inverter, thus cooling the electric motor and the inverter.

With respect to the electric working vehicle, the present inventor has intensively studied cooling structures for the electric motor and the inverter.

First, a configuration in which the electric motor and the inverter are arranged in the same space in a device compartment has been examined. However, with the working vehicle having this configuration, there is a case where, particularly at the time of cleaning or the like of the upper body, water enters from the opening and the terminal connection part of the inverter is soaked with the water.

Also, in consideration of the layout of the connection cable between the electric motor and the inverter, a configuration in which the inverter is arranged such that the terminal connection part is on the side facing the electric motor whereas the heat dissipator is on the opposite side has been examined. However, there is a case where when the cooling air taken in from the opening is to be applied to the electric motor, it is difficult to apply the cooling air to the heat dissipator of the inverter and therefore the cooling efficiency of the inverter decreases.

The present invention has been accomplished under the above-described circumstances and an object thereof is to provide a working vehicle and a manufacturing method therefor in which an inverter can be efficiently cooled and in which a terminal connection part of the inverter can be prevented from being soaked with water entering from an opening.

### Solution to Problem

The present invention solves the above-described problems by a solution as described below as an embodiment.

A working vehicle according to an embodiment is a working vehicle including an upper body having a device compartment, and a hydraulically operating working device, and the device compartment is provided with an electric motor serving as a drive source of the working device, and an inverter supplying electricity to the electric motor, and the device compartment includes a partition member separating an internal space into a first space where the electric motor is arranged and a second space on a side opposite thereto, and the inverter is attached to the partition member and has a heat dissipator arranged in the first space and a terminal connection part arranged in the second space.

A method for manufacturing a working vehicle according to an embodiment is a method for manufacturing a working vehicle including an upper body having a device compartment, a lower body, a hydraulically operating working device, an electric motor serving as a drive source of the working device, and an inverter supplying electricity to the electric motor, and the method includes an attachment step of attaching a partition member separating an internal space of the device compartment, to the upper body, and the attachment step includes a step of attaching the partition member to the upper body such that the partition member is arranged between the electric motor and a heat dissipator provided at one surface of the inverter, and a terminal connection part provided at a surface opposite to the one surface of the inverter.

### Advantageous Effects of Invention

In the working vehicle according to the embodiment, the inverter can be efficiently cooled. Also, the terminal connection part of the inverter can be prevented from being soaked with water entering from the opening.

### BRIEF DESCRIPTION OF DRAWINGS

FIG. 1 is a perspective view showing an example of a working vehicle according to an embodiment of the present invention.

FIG. 2 is a perspective view showing an example of an upper body of the working vehicle shown in FIG. 1.

FIG. 3 is a perspective view showing an example of the upper body of the working vehicle shown in FIG. 1.

FIG. 4 is a perspective view showing an example of a partition member of the working vehicle shown in FIG. 1.

FIG. 5 is a perspective view showing an example of the partition member of the working vehicle shown in FIG. 1.

FIG. 6 is a perspective view showing an example of the partition member of the working vehicle shown in FIG. 1.

FIG. 7 is a plan view showing a configuration inside a device compartment of the working vehicle shown in FIG. 1.

### DESCRIPTION OF EMBODIMENTS

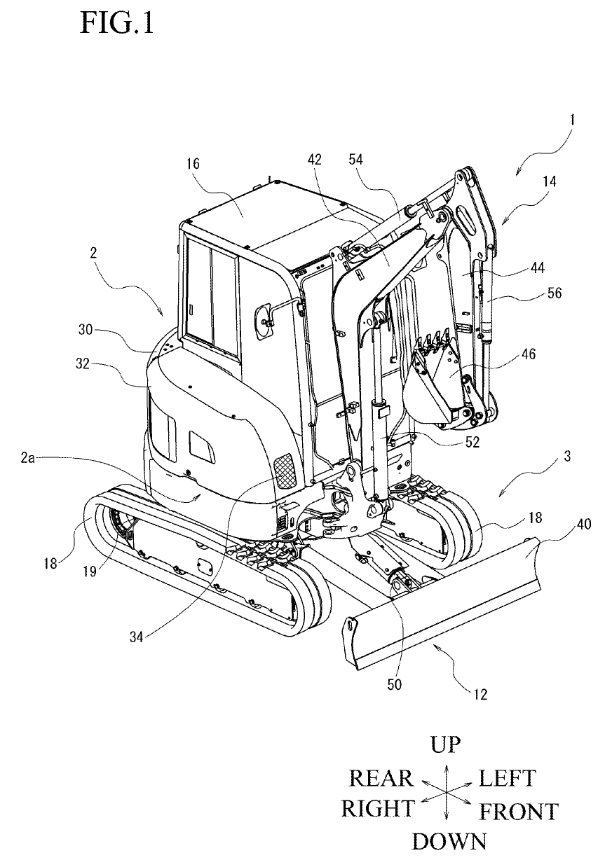

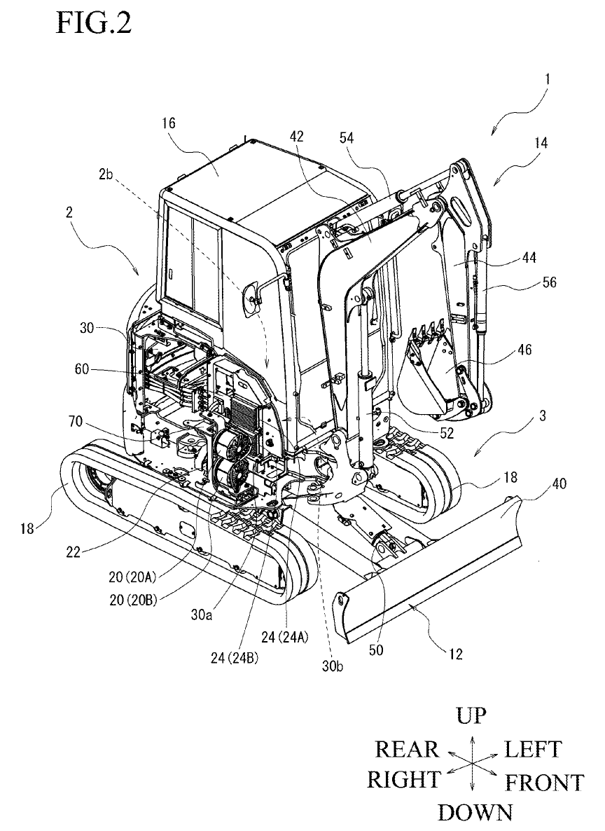

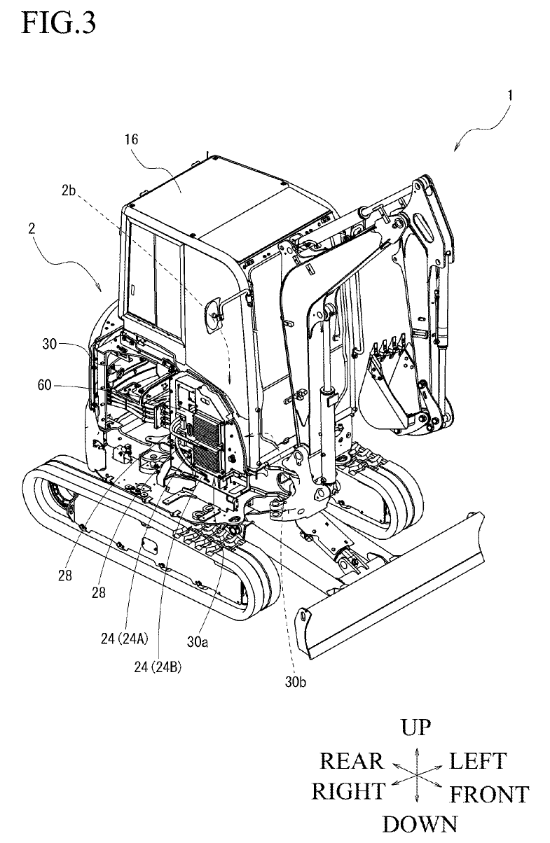

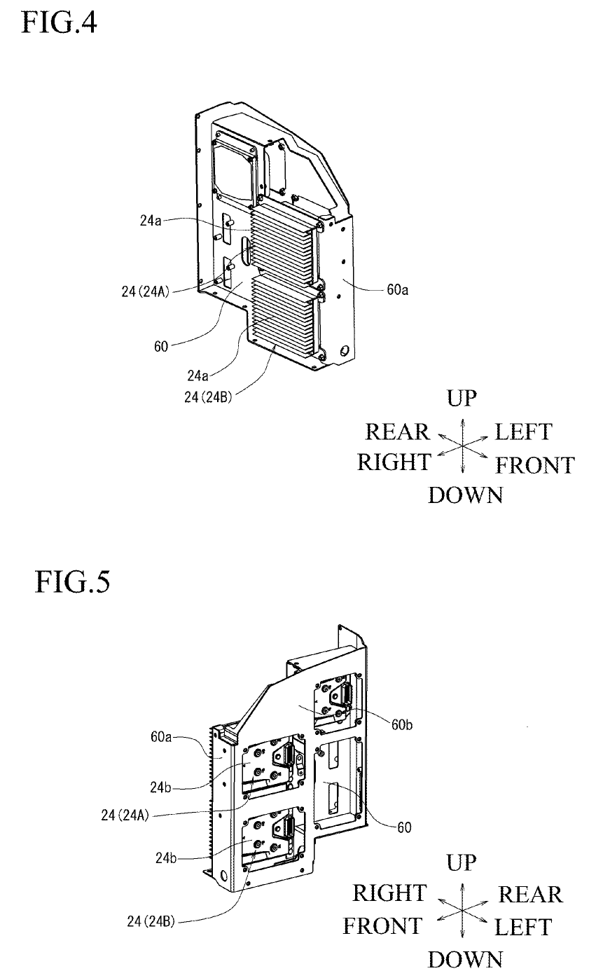

Hereinafter, an embodiment of the present invention will be described in detail with reference to the drawings. FIG. 1 is a schematic view (perspective view from above a right front part) showing an example of a working vehicle 1 according to the present embodiment. Also, FIG. 2 is a perspective view (perspective view from above a right front part) showing an example of an upper body 2 (in a state where a cover 32 is removed) of the working vehicle 1 shown in FIG. 1. FIG. 3 is a perspective view of a state where an electric motor 20 and a bracket 70 supporting the electric motor 20 or the like in FIG. 2 are not illustrated. For the sake of convenience of description, there are cases where upward and downward, left and right, and forward and backward directions are indicated by arrows in the drawings. Also, there are cases where members having the same function are denoted by the same sign in all the drawings for illustrating the embodiment and the repeated description thereof is omitted.

First, the overall configuration of the working vehicle 1 will be described. A hydraulic excavator will be described as an example of the working vehicle 1. However, the working vehicle 1 is not limited to the hydraulic excavator.

As shown in FIG. 1, the working vehicle 1 has a lower body 3 provided with a traveling device, and the upper body 2 arranged above the lower body 3. This working vehicle 1 has working devices 12, 14 that operate hydraulically (with hydraulic oil having a predetermined pressure). Also, a cab 16 provided with an operation device (not illustrated) with which an operator on board carries out operations for traveling and work is provided. The cab 16 is assumed to be a closed type (cabin) but may also be an open type (canopy).

As an example of the traveling device of the lower body 3, a pair of left and right crawlers 18 are provided. However, the traveling device of the lower body 3 is not limited to the crawlers 18 and may employ a configuration having tires instead of the crawlers 18 (not illustrated). The crawlers 18 are driven by a traveling hydraulic motor 19.

As an example of the working device 12, a blade 40 is provided. The blade 40 is installed at the lower body 3 so as to be able to swing upward and downward (including forward and backward components). The blade 40 is driven by a hydraulic cylinder (blade cylinder) 50. However, the working device 12 is not limited to the above-described configuration.

As an example of the working device 14, a boom 42, an arm 44, and an attachment (in the present embodiment, a bucket) 46 are provided. However, the attachment 46 is not limited to the bucket. The boom 42 is installed at the upper body 2 so as to be able to swing upward and downward (including forward and backward components) (A boom bracket may or may not be provided in therebetween.). The arm 44 is installed at the boom 42 so as to be able to swing upward and downward (including forward and backward components). The attachment 46 is installed at the arm 44 so as to be able to swing upward and downward (including forward and backward components). The boom 42 is driven by a hydraulic cylinder (boom cylinder) 52. The arm 44 is driven by a hydraulic cylinder (arm cylinder) 54. The attachment 46 is driven by a hydraulic cylinder (bucket cylinder) 56. However, the working device 14 is not limited to the above-described configuration.

As shown in FIG. 2, the working vehicle 1 has a drive source 20, a hydraulic pump 22 as a driven device driven by the drive source 20, a control valve (not illustrated) and the like, as a drive mechanism for driving the above-described traveling hydraulic motor 19 and hydraulic cylinders 50, 52, 54, 56. One or a plurality of hydraulic pumps 22 are provided in accordance with the configurations, loads and the like of the working devices 12, 14 and the traveling device or the like.

In the working vehicle 1 having the above-described configuration, the operator operates the operation device (not illustrated) and thus performs control to activate the control valve to supply hydraulic oil with a predetermined pressure sent out from the hydraulic pump 22 to the traveling hydraulic motor 19 and the hydraulic cylinders 50, 52, 54, 56. Thus, the traveling of the working vehicle 1 and the work by the working devices 12, 14 can be performed.

In the present embodiment, an electric motor is provided as the above-described drive source 20. Also, an inverter 24 that supplies electricity (alternating current) to this electric motor 20 is provided. As an example, the electric motor 20 is an AC motor and the specifications thereof (the number of electric motors and the rated output thereof or the like) are set as appropriate in accordance with the number of the driven devices 22 and the rated output thereof or the like. Also, the inverter 24 is provided with a heat dissipator 24a performing heat radiation (cooling) at one surface, and a terminal connection part 24b to which electrical cables 26, 28, described later, are connected, at the other surface opposite to the one surface.

Also, as an example, the driven device 22 driven by the electric motor 20 is a hydraulic pump that sends out hydraulic oil with a predetermined pressure which causes the working devices 12, 14 or a traveling device, a slewing device or the like to operate. Alternatively, as another example, the driven device 22 is the compressor of an air conditioner that performs air conditioning in the cab 16. However, the driven device 22 is not limited to these examples.

The working vehicle 1 according to the present embodiment has two electric motors 20 (20A, 20B) and two inverters 24 (24A, 24B) supplying electricity to the electric motors 20 (20A, 20B), respectively, and these electric motors and inverters are connected by a connection cable 28. However, the present invention is not limited to this configuration, and a configuration in which one electric motor and one inverter are provided or a configuration in which three or more electric motors and three or more inverters are provided may be employed (not illustrated).

As an example, the electric motor 20 and the driven device 22 are supported by the bracket 70 in a state where two sets of the electric motor 20 and the driven device 22 are provided in parallel one above the other. This bracket 70 is formed using a plate-shaped steel material and is fixed to the upper body 2 (device compartment 30, described later), using bolts at four points in a lower part.

The working vehicle 1 according to the present embodiment has, in the upper body 2, a device compartment 30 where the electric motor 20, the inverter 24, and the driven device 22 or the like are installed, and the cover 32 covering the device compartment 30 so as to be able to open and close (FIG. 2 shows a state where the cover 32 is removed.). The cover 32 is provided with an opening 34 to take in cooling air to the inside of the device compartment 30, at the front surface thereof, and a blower fan (not illustrated) at a position that is on the back side (inside the compartment) of this opening 34. A battery (for example, a lithium-ion rechargeable battery) or the like that supplies electric power for driving the electric motor 20 is installed in a rear part of the device compartment 30 (not illustrated).

As a characteristic configuration in the present embodiment, the device compartment 30 has a partition member 60 separating the internal space into a first space 30a where the electric motor 20 is arranged and a second space 30b on the side opposite to this first space 30a. As an example, the partition member 60 is formed using a plate-shaped steel material. It is not essential that the partition member 60 separates the first space 30a and the second space 30b in a completely airtight state.

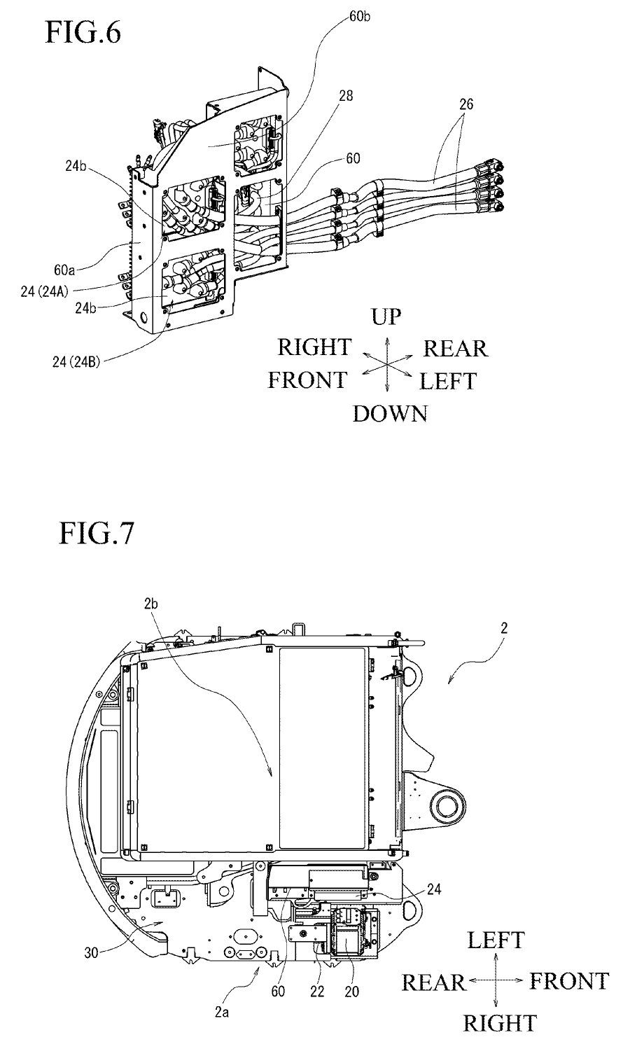

Also, the partition member 60 according to the present embodiment is provided with a front cover 60a on the front side (position to be on the front side when installed in the upper body 2), and is provided with an inner cover 60b on the inner side (position to be on the cab 16 side when installed in the upper body 2). Thus, a box-shaped space can be formed on the inner side of the partition member 60, and electrical cables such as a high-voltage cable 26 and the connection cable 28 can be accommodated and supported therein (see FIG. 6). However, the partition member 60 is not limited to this configuration.

Here, the inverter 24 is attached to the partition member 60 such that the heat dissipator 24a is arranged in the first space 30a and the terminal connection part 24b is arranged in the second space 30b.

With this configuration, the above-described problems can be solved. That is, an advantageous effect is achieved in that the partition member 60 rectifies the flow of cooling air to effectively apply the cooling air not only to the electric motor 20 but also to the heat dissipator 24a of the inverter 24. Therefore, efficient cooling can be performed for both the electric motor 20 and the heat dissipator 24a of the inverter 24. Moreover, the partition member 60 can isolate the terminal connection part 24b of the inverter 24 having a high voltage, in the second space 30b on the cab 16 side, which is the side opposite to the first space 30a where the electric motor 20 is arranged. Therefore, the terminal connection part 24b can be prevented from being soaked with water due to the entry of water from the opening 34. In other words, any partition structure that has a cooling air flow rectifying effect and a water entry prevention effect can be employed as the partition member 60.

Also, since a configuration in which the electric motor 20, the heat dissipator 24a of the inverter 24, the partition member 60 supporting the inverter 24, and the terminal connection part 24b of the inverter 24 are arranged in this order is provided inside the device compartment 30, the following effects can be achieved as well.

Specifically, with the partition member 60, the terminal connection part 24b of the inverter 24 to which electrical cables such as the high-voltage cable 26 and the connection cable 28 (see FIG. 6) for supplying electricity for driving the electric motor 20 are connected can be arranged not on the side where the heat source such as the electric motor 20 is arranged (the side of a sidewall part 2a of the upper body 2) but on the cab 16 side opposite thereto (the side of a center part 2b of the upper body 2). Therefore, even if by any chance the working vehicle 1 rolls over and the cover 32 of the device compartment 30 is damaged, the risk factor leading to the outbreak of a fire due to the crushing of the electrical cables (particularly the high-voltage cable 26) can be reduced and safety can be improved. Also, with respect to the layout (bending) of the connection cable 28 between the electric motor 20 and the inverter 24, a reasonable arrangement can be implemented. This is because the element (partition member 60 or the like) is provided between the electric motor 20 and the terminal connection part 24b and increases the distance therebetween, thus eliminating the need to connect the connection cable 28 in a forcibly bent state. Therefore, the risk of breaking of the connection cable 28 due to an excessive force applied thereto can be reduced and consequently safety can be improved.

Also, in the present embodiment, a configuration in which the electric motor 20 and the inverter 24 are arranged side by side in a lateral direction (that is, the left-and-right direction of the upper body 2) in a plan view is provided inside the device compartment 30 (see FIG. 7). Thus, since the electric motor 20 and the heat dissipator 24a of the inverter 24 are arranged side by side, the cooling air whose flow is rectified by the partition member 60 is efficiently applied to these heat sources and therefore the inside of the device compartment 30 can be effectively cooled.

Although the method for installing the inverter 24 in the upper body 2 is not particularly limited, in the present embodiment, the inverter 24 is configured to be installed in the device compartment 30 (where the arrangement position of each device is as described above) after a state where the inverter 24 is attached to the partition member 60 (this state is referred to as an assembly state) is created. Thus, the partition member 60 in the assembly state with the inverter 24 attached can be installed in the device compartment 30. Therefore, workability (assemblability) can be significantly improved, as compared with a method of installing the inverter 24 on the manufacturing line as in the related art.

The other mechanisms for traveling and work in the working vehicle 1 according to the present embodiment are similar to those in a known working vehicle (hydraulic excavator) and therefore the detailed description thereof is omitted.

As described above, it is preferable that the present invention includes the configurations given below.
(1) A working vehicle according to an embodiment is a working vehicle including an upper body having a device compartment, and a hydraulically operating working device, and the device compartment is provided with an electric motor serving as a drive source of the working device, and an inverter supplying electricity to the electric motor, and the device compartment includes a partition member separating an internal space into a first space where the electric motor is arranged and a second space on a side opposite thereto, and the inverter is attached to the partition member and has a heat dissipator arranged in the first space and a terminal connection part arranged in the second space.
(2) In the working vehicle according to the above aspect (1), it is preferable that an electric cable supplying electricity for driving the electric motor is connected to the terminal connection part, that the first space is defined on a sidewall part side of the upper body in relation to the partition member, and that the second space is defined on a center part side of the upper body in relation to the partition member.
(3) In the working vehicle according to the above aspect (1) or (2), it is preferable that, in the device compartment, a configuration in which the electric motor, the heat dissipator, the partition member, and the terminal connection part are arranged in this order is provided.
(4) In the working vehicle according to any one of the above aspects (1) to (3), it is preferable that, in the device compartment, a configuration in which the electric motor and the inverter are arranged side by side in a lateral direction in a plan view is provided.
(5) A method for manufacturing a working vehicle according to an embodiment is a method for manufacturing a working vehicle including an upper body having a device compartment, and a hydraulically operating working device, the device compartment being provided with an electric motor serving as a drive source of the working device, and an inverter supplying electricity to the electric motor, and the method includes an attachment step of attaching a partition member separating an internal space of the device compartment, to the upper body, and the attachment step includes a step of attaching the inverter to the partition member such that the partition member is arranged between a heat dissipator provided at one surface of the inverter and a terminal connection part provided at a surface opposite to the one surface of the inverter.
(6) In the method for manufacturing the working vehicle according to the above aspect (5), it is preferable that the attachment step includes a step of attaching the partition member to the upper body after attaching the inverter to the partition member.

According to the present invention, in the working vehicle having the electric motor, the flow of cooling air is rectified by the partition member and therefore can efficiently cool the electric motor and the heat dissipator of the inverter. Also, the terminal connection part of the inverter can be isolated on the side opposite to the electric motor by the partition member and therefore can be prevented from being soaked with water due to the entry of water from the opening. Moreover, assemblability at the time of manufacturing this vehicle can be enhanced.

The present invention is not limited to the above-described embodiment (hydraulic excavator). For example, while a hydraulic excavator has been described as an example of the working vehicle, the present invention can be similarly applied to a track loader or the like in which an upper body does not slew in relation to a lower body. Also, while a configuration in which two electric motors and two inverters are provided has been described as an example, the present invention can be similarly applied to a configuration in which at least either one or three or more electric motors or one or three or more inverters are provided.

What is claimed is:

1. A working vehicle comprising an upper body having a device compartment, and a hydraulically operating working device, wherein
the device compartment is provided with an electric motor serving as a drive source of the working device, and an inverter supplying electricity to the electric motor,
the device compartment includes a partition member separating an internal space thereof into a first space where the electric motor is arranged and a second space on a side opposite to the first space, and
the inverter is attached to the partition member and has a heat dissipator arranged in the first space and a terminal connection part arranged in the second space.

2. The working vehicle according to claim 1, wherein
an electric cable supplying electricity for driving the electric motor is connected to the terminal connection part,
the first space is defined on a sidewall part side of the upper body in relation to the partition member, and
the second space is defined on a center part side of the upper body in relation to the partition member.

3. The working vehicle according to claim 1, wherein
in the device compartment, a configuration in which the electric motor, the heat dissipator, the partition member, and the terminal connection part are arranged in this order is provided.

4. The working vehicle according to claim 1, wherein
in the device compartment, a configuration in which the electric motor and the inverter are arranged side by side in a lateral direction in a plan view is provided.

5. A method for manufacturing a working vehicle, the working vehicle comprising an upper body having a device compartment, and a hydraulically operating working device, the device compartment being provided with an electric motor serving as a drive source of the working device, and an inverter supplying electricity to the electric motor,
the method comprising an attachment step of attaching a partition member separating an internal space of the device compartment, to the upper body, wherein
the attachment step includes a step of attaching the inverter to the partition member such that the partition member is arranged between a heat dissipator provided at one surface of the inverter and a terminal connection part provided at a surface opposite to the one surface of the inverter.

6. The method for manufacturing the working vehicle according to claim 5, wherein
the attachment step includes a step of attaching the partition member to the upper body after attaching the inverter to the partition member.
